(19) United States
(12) Patent Application Publication
(10) Pub. No.: US 2003/0058292 A1
(43) Pub. Date: Mar. 27, 2003

(54) Droplet deposition apparatus

(76) Inventors: Werner Zapka, Jarfalla (SE); Bosse Nilsson, Jarfalla (SE); Mike De Roos, Jarfalla (SE)

Correspondence Address: MARSHALL, GERSTEIN & BORUN, 6300 SEARS TOWER, 233 SOUTH WACKER, CHICAGO, IL, 60606-6357, US

(21) Appl. No.: 10/146,373

(22) Filed: May 15, 2002

Related U.S. Application Data
(63) Continuation of application No. PCT/GB00/04394, filed on Nov. 17, 2000.

(30) Foreign Application Priority Data
Nov. 17, 1999 (SE) 9904155-0
Sep. 21, 2000 (GB) 0023224.9

(51) Int. Cl. B41J 29/38

(52) U.S. Cl. 347/17; 347/14

(57) ABSTRACT

Droplet deposition apparatus, in which the capacitance of walls of dummy chambers in the printhead is used to provide an indication of the temperature of the droplet fluid to enable the magnitude of the actuating electrical signals applied to the actuable walls of the fluid ejection chambers to be adjusted.

The present invention relates to a droplet deposition apparatus such as, for example, a drop-on-demand inkjet printer.

In particular the invention is concerned with a printer or other droplet deposition apparatus in which an acoustic pressure wave is generated by an electrical signal to eject a droplet of fluid (e.g. ink) from a chamber. The apparatus may have a single such droplet ejection chamber, but more typically has a printhead with an array of such chambers each with a respective nozzle, the printhead receiving data-carrying actuating electrical signals which provide the power necessary to eject droplets from the chambers on demand. Each chamber is bounded by a piezoelectric element which is caused to deflect by the actuating electrical signal, thereby generating the acoustic pressure wave which ejects the droplet. Reference is made to our published specifications EP 0277703, U.S. Pat. No. 4,887,100 and WO91/17051 for further details of typical constructions.

These specifications describe arrangements in which piezoelectric material is in a “chevron” configuration, in which a longitudinal side of the chamber is bounded by piezoelectric material having oppositely-poled regions extending longitudinally of the chamber, so that application of the electrical signal deforms both regions of the material in the same direction and into a chevron shape, when viewed in cross-section. Such a configuration is described in the context of an “end-shooter” print-head in EP 0277703, in which the nozzle is at the end of elongated chamber and the piezoelectric material is disposed along the sides of the chamber. Alternatively or in addition, the printhead can be configured as a “side shooter” as described in WO91/17051 in which the nozzle is instead disposed in one of the long sides of the chamber which is not bounded by piezoelectric material. Both of these designs provide significant reductions in the drive voltage for a given droplet ejection performance.

During printing, heat is generated by, for example, the drive circuitry providing the actuating electrical signals to the piezoelectric material. This heat dissipates into the ejection chambers and heats up the ejection fluid therein. This gives rise to a decrease in the viscosity of the ejection fluid. Such variations in the viscosity of the ejection fluid can give rise to variations in droplet ejection velocity and consequent dot placement errors in the printed image.

It is therefore desirable to monitor the temperature of the droplet ejection fluid during printing and adjust the magnitude of the actuating signals in response to the monitored temperature. One known technique is to mount a thermistor on the external surface of the printhead in the proximity of a piezoelectric element, the thermistor being electrically connected to the drive circuitry. Any temperature increase in the location of the thermistor thus causes a reduction in a resistance value of the drive circuitry, which is used to reduce the magnitude of the actuating electrical signals applied to the piezoelectric element. However, the thermal insulation provided between the thermistor and the piezoelectric element by the casing of the printhead and the glue layer attaching the thermistor to the casing results in a difference between the temperature at the thermistor and the temperature of the droplet ejection fluid. This difference can be substantial if there are fast temperature changes in the printhead during printing, as there is a slow reactance of the drive circuitry to the temperature changes in the ejection fluid.

The preferred embodiments of the present invention seek to solve these and other problems.

In a first aspect, the present invention provides droplet deposition apparatus including an array of fluid-receiving chambers comprising a plurality of fluid ejection chambers and at least one dummy chamber, each fluid ejection chamber comprising means for ejecting a droplet therefrom in response to an electrical actuating signal, characterised by:

means exposed to fluid in the dummy chamber to provide a signal dependent on the temperature of that fluid; and

means responsive to the temperature dependent signal for adjusting the actuating electrical signals.

Preferably, each fluid ejection chamber is defined in part by at least one wall actuable by an electrical signal to effect droplet ejection from that chamber, a corresponding wall of each dummy chamber being non-actuable, the apparatus comprising means for utilising a temperature dependent electrical property of at least a portion of a wall of a dummy chamber to provide said signal. Thus, in a second aspect, the present invention provides droplet deposition apparatus comprising:

a plurality of fluid chambers comprising at least one fluid ejection chamber and at least one dummy chamber, each fluid ejection chamber being defined in part by at least one wall actuable by an electrical signal to effect droplet ejection from that chamber, a corresponding wall of each dummy chamber being non-actuable;

characterised by further comprising:

means for utilising a temperature dependent electrical property of at least a portion of a wall of a dummy chamber to provide a signal having a magnitude dependant on the temperature of fluid in the fluid chambers; and

means for adjusting the actuating electrical signals depending on the magnitude of the temperature dependant signal.

The inventors of the present application have realised the importance of ensuring that any temperature sensor should be in direct contact with the ejection fluid during printing. The inventors have also realised that any such temperature sensing should not interfere with the standard printing operations of the printhead.

Accordingly, the present invention can utilise, as an example of means exposed to fluid in the dummy chamber, a temperature dependent electrical property of a wall, preferably the non-actuable wall, of a dummy chamber to monitor the temperature of ejection fluid during printing. By the term “dummy chamber”, we mean a fluid chamber from which fluid is not, or not intended to be, ejected during printing. As the wall is in direct contact with the ejection fluid, any change in the temperature of the fluid can be detected and acted upon quickly. Furthermore, as the wall is preferably non-actuable any necessary application of electrical signals to the wall to measure or otherwise utilise the chosen electrical property of the wall has no influence on the standard printing operation of the printhead. Alternatively, a separate temperature sensor may be located in a dummy chamber.

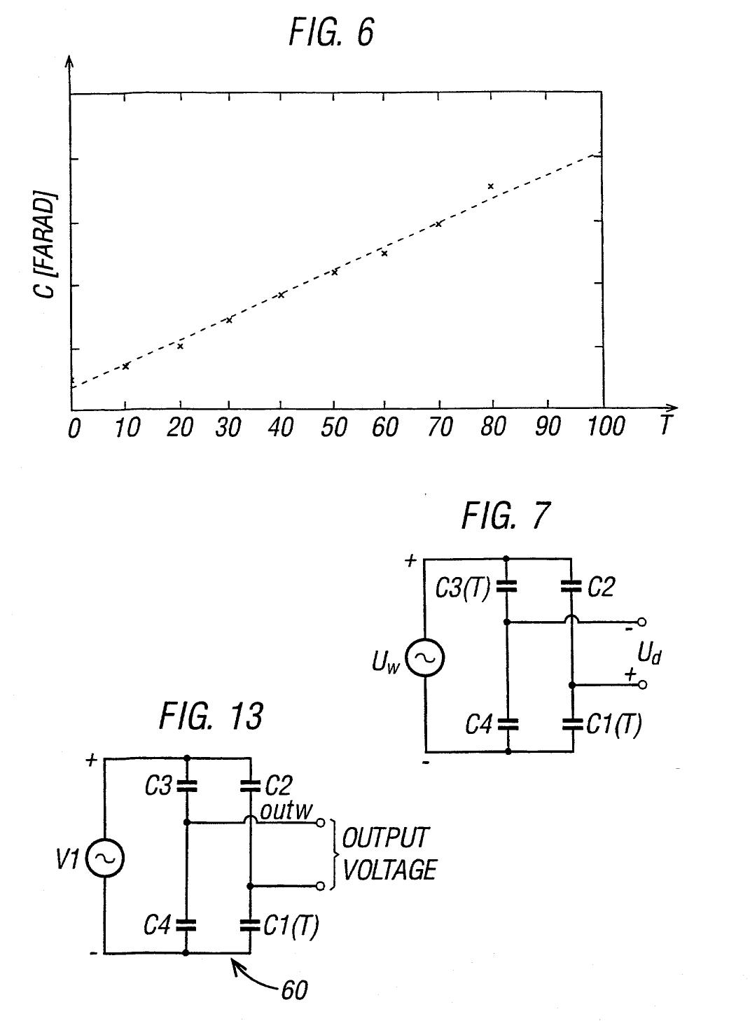

In a preferred embodiment, said temperature dependent electrical property is electrical capacitance. With reference to FIG. 6, the inventors of the present application have found, and verified experimentally, that the capacitance of the actuable wall of a fluid chamber is a substantially linear function of temperature. As a consequence, the magnitude of the temperature dependent signal can be directly proportional to the temperature of the ink. However, it is not essential that the property of electrical capacitance is used to provide an indication of the fluid temperature, as any other property which varies either linearly or non-linearly with temperature could be used to enable the magnitude of the actuating electrical signals to be adjusted.

Preferably, said at least one fluid ejection chamber is located between a pair of dummy chambers, and the utilising means utilizes the electrical property of at least a portion of a wall of each dummy channel to provide a signal having a magnitude dependant on the temperature of fluid in the fluid chambers.

Preferably, the utilising means comprises a reference capacitance, the capacitance value of which is substantially unaffected by the temperature and which, in combination with said portion, is coupled as a voltage divider such that a sensor output voltage is generated, the adjusting means being coupled so as to receive the sensor output voltage.

In one preferred embodiment, the utilising means comprises a bridge circuit having four arms, each one of two arms of the bridge circuit comprising said portion of a wall of a respective dummy chamber. Thus, a simple analog circuit may be employed to utilise the electrical property of the walls to provide the temperature dependent signal. Preferably, each of the other two arms of the bridge circuit comprises a temperature independent capacitor, the capacitance of each capacitor being substantially equal to the capacitance of each portion of said wall at room temperature. Thus, any deviation of the temperature of the fluid in the fluid chambers from room temperature would result in the output of a signal from the bridge circuit, the magnitude of the signal being dependent on the fluid temperature.

The adjusting means preferably comprises means for adjusting the peak voltage level of the actuating electrical signals. The apparatus preferably comprises means for shaping said temperature dependent signal to provide a temperature dependent voltage signal for superimposition by said adjusting means on said actuating electrical signals. The shaping means may adopt any suitable arrangement according to whether that signal varies linearly or non-linearly with temperature.

Preferably, said walls are formed from piezoelectric material, such as PZT. If so, each actuable channel wall may be deformable upon the application of an actuating electrical signal to eject fluid from a fluid ejection chamber. Preferably, the piezoelectric material is such that application of the actuating electrical signal deforms it in shear mode to generate an acoustic pressure wave in the fluid ejection chamber and thereby eject said fluid.

In a preferred arrangement, the piezoelectric material is disposed along the sides of each fluid chamber. The droplet deposition apparatus can take either an “end-shooter” or “side shooter” configuration. Alternatively, piezoelectric material may be disposed at the back of each fluid chamber, as described in our published specification WO00/16981, so that application of an actuating signal to the piezoelectric material causes it to move towards or away from the nozzle of the ejection chamber, thereby generating the required acoustic pressure wave for fluid ejection.

In a third aspect the present invention provides a method of temperature compensation in droplet deposition apparatus having an array of liquid-containing channels, at least one of which is a dummy channel, the others being droplet-ejection channels, characterised by controlling a droplet-ejection signal to a droplet-ejection channel in response to a signal which is dependent upon the temperature of liquid in a dummy channel.

In a fourth aspect the present invention provides a method of operating droplet deposition apparatus comprising a plurality of fluid chambers comprising at least one fluid ejection chamber and a pair of dummy chambers, each fluid ejection chamber being defined in part by at least one wall actuable by an electrical signal to effect droplet ejection from that chamber, a corresponding wall of each dummy chamber being non-actuable, said method being characterised by comprising the steps of:

utilising a temperature dependent electrical property of a wall of a dummy chamber to provide a signal having a magnitude dependant on the temperature of fluid in the fluid chambers; and

adjusting the magnitude of the actuating electrical signals depending on the magnitude of the temperature dependant signal.

The present invention also provides droplet deposition apparatus comprising:

an actuator having a plurality of spaced piezoelectric walls defining channels, said walls having opposed sides; said opposed sides being provided with electrodes adapted to receive electric signals to deform said walls to cause liquid in said channels to be ejected therefrom; and

a control unit for defining wave forms of said electric signals and comprising means for measuring an impedance in at least one piezoelectric portion of the actuator, and means for adjusting the wave forms of said electric signals in response to the measured impedance. Preferably, said at least one portion of the actuator includes at least one of the walls.

The present invention further provides a control unit for a piezoelectric actuator having a plurality of spaced piezoelectric walls defining channels, said walls having opposed sides provided with electrodes adapted to receive electric signals to deform said walls to cause liquid in said channels to be ejected therefrom; the control unit comprising:

a plurality of controllable drive signal sources for generating electric signals to deform said walls;

means for measuring an impedance, preferably capacitance, in at least one piezoelectric portion of the actuator; and

means for adjusting the wave forms of said electric signals in response to the measured impedance.

The present invention also provides an ink jet printer having a control unit as aforementioned.

Preferred features of the present invention will now be described, by way of example only, with reference to the accompanying drawings in which:

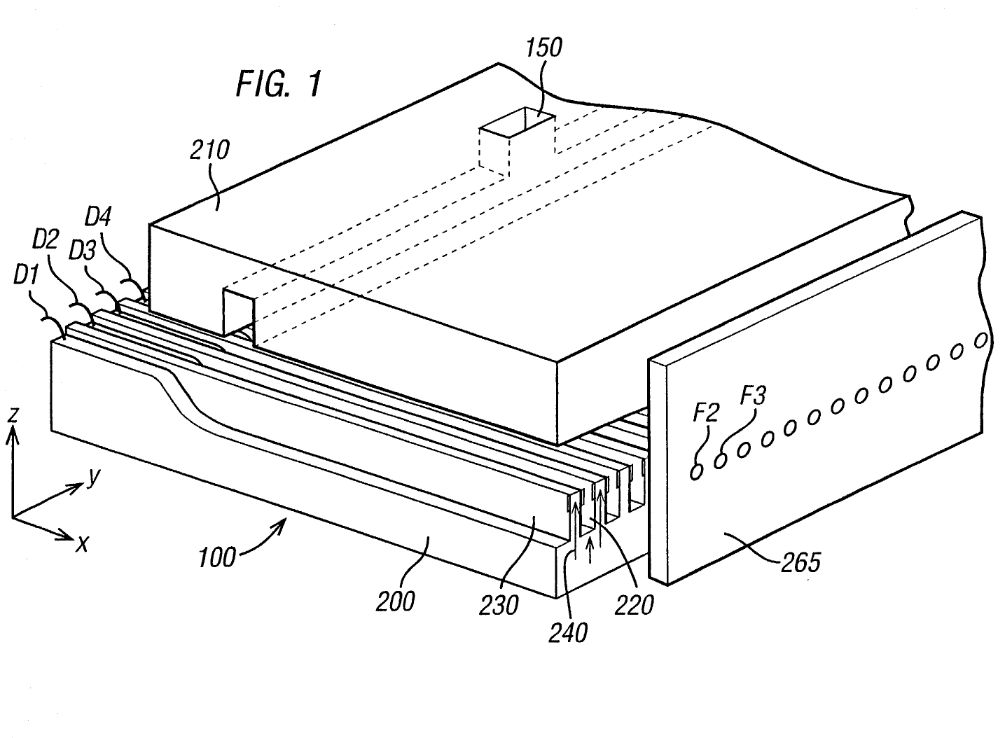

FIG. 1 is an exploded partly diagrammatic perspective view of a part of an actuator having an actuator plate and a cover plate.

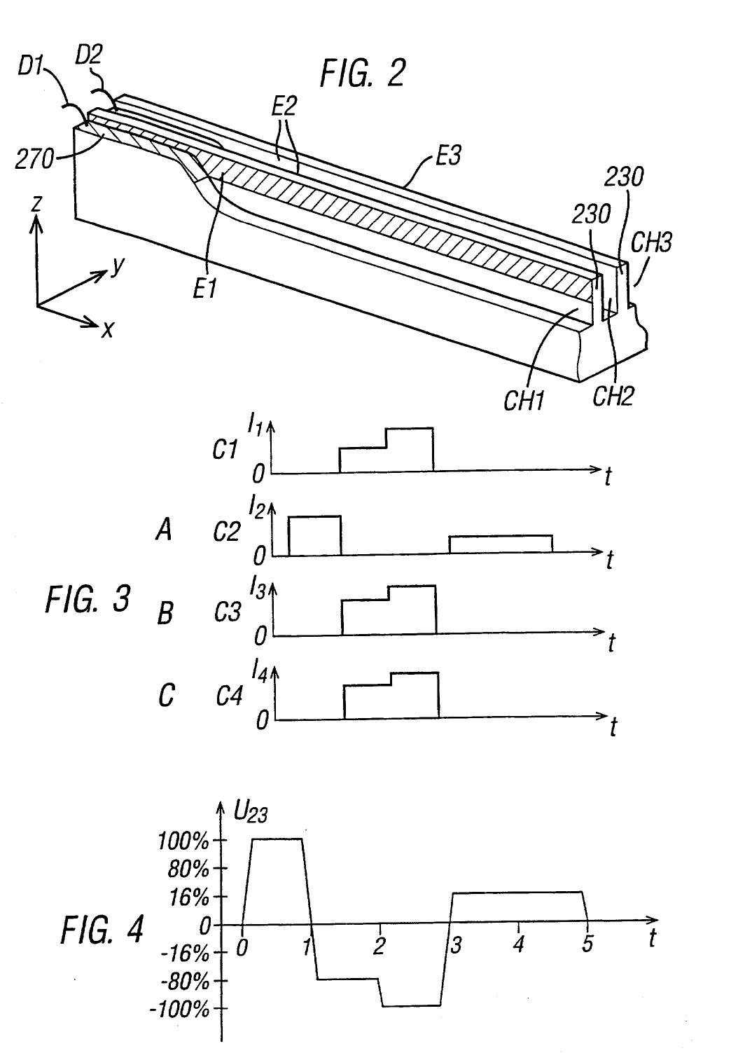

FIG. 2 is a sectional perspective view of a part of the actuator plate, shown in FIG. 1, having walls with electrodes.

FIG. 3 illustrates examples of electric pulses delivered to electrodes on actuator walls shown in FIG. 2.

FIG. 4 illustrates an example of an electric signal wave form relating to two opposing electrodes in response to pulses shown in FIG. 3.

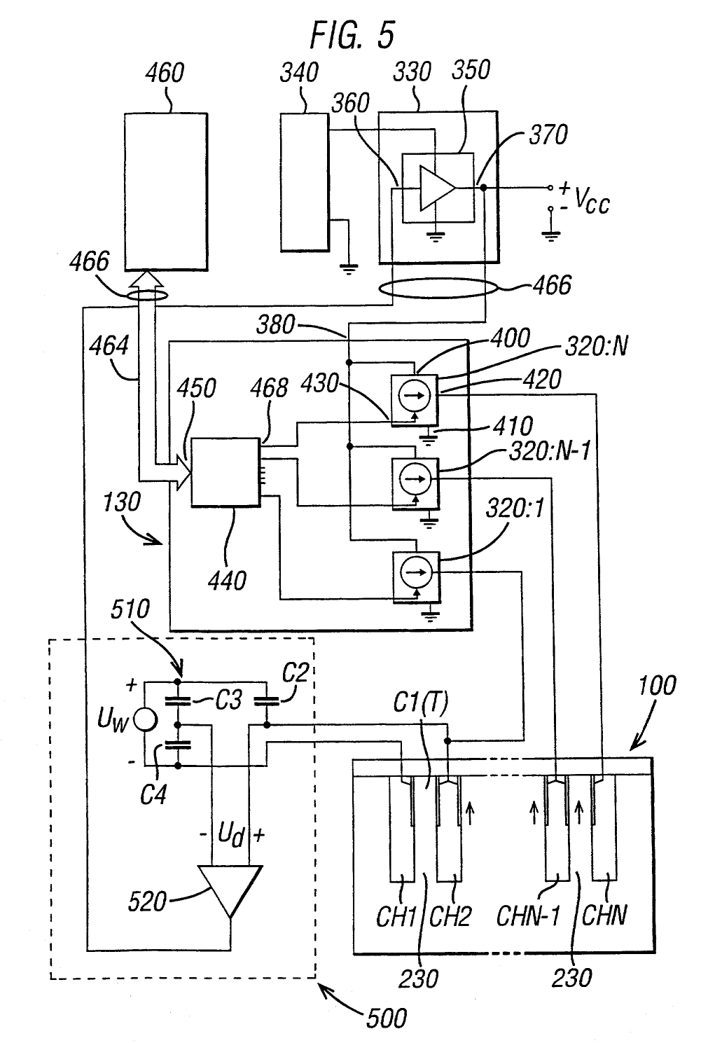

FIG. 5 is a block diagram of an embodiment of the invention, comprising an actuator control circuit, a power supply circuit, an actuator and a temperature sensor.

FIG. 6 illustrates the relation between the temperature of an actuator wall and the capacitance of the wall.

FIG. 7 illustrates an embodiment of a Wheatstone bridge having four capacitors.

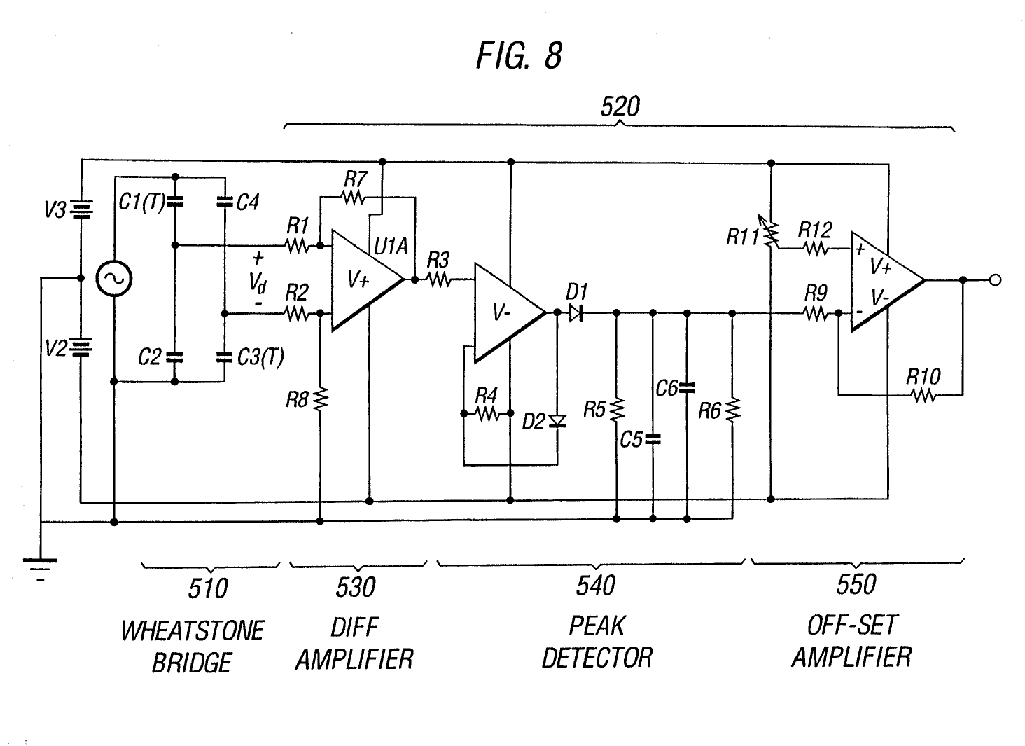

FIG. 8 illustrates an embodiment of a Wheatstone bridge and an amplifier.

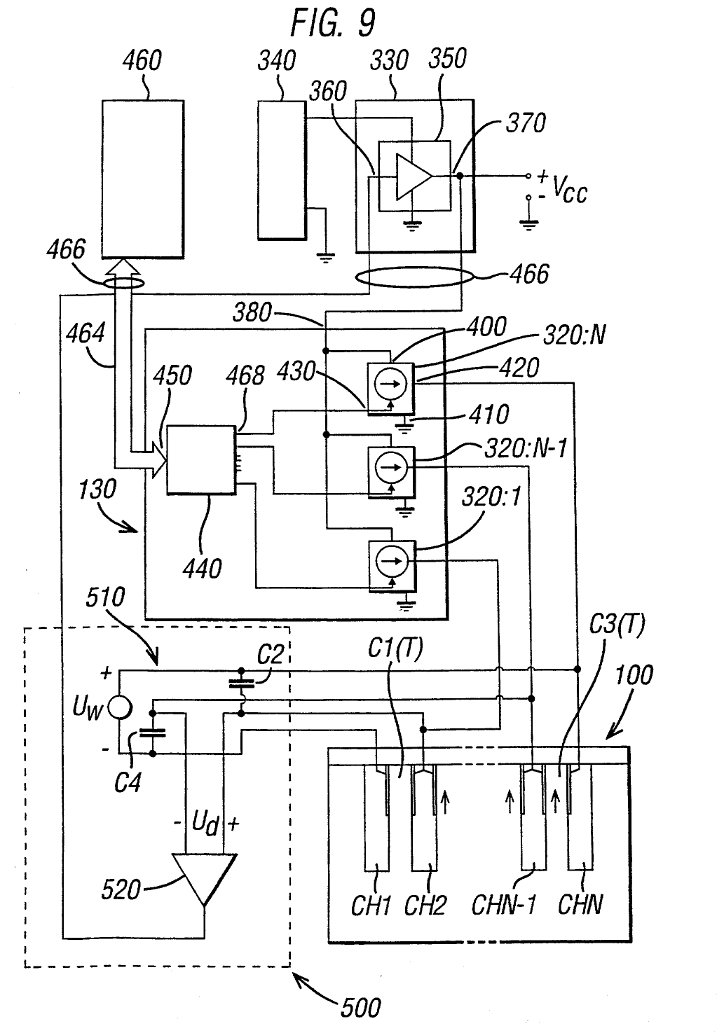

FIG. 9 illustrates another embodiment of the invention, comprising a temperature sensor including a Wheatstone bridge with two active elements.

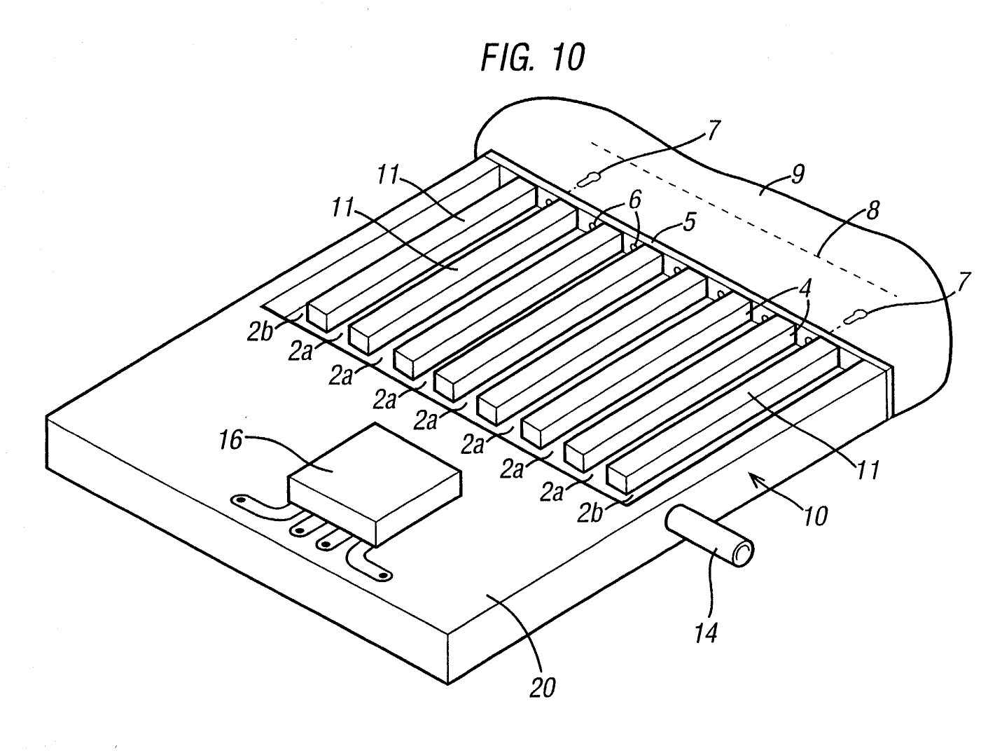

FIG. 10 is a perspective view of an end-shooter chevron printhead;

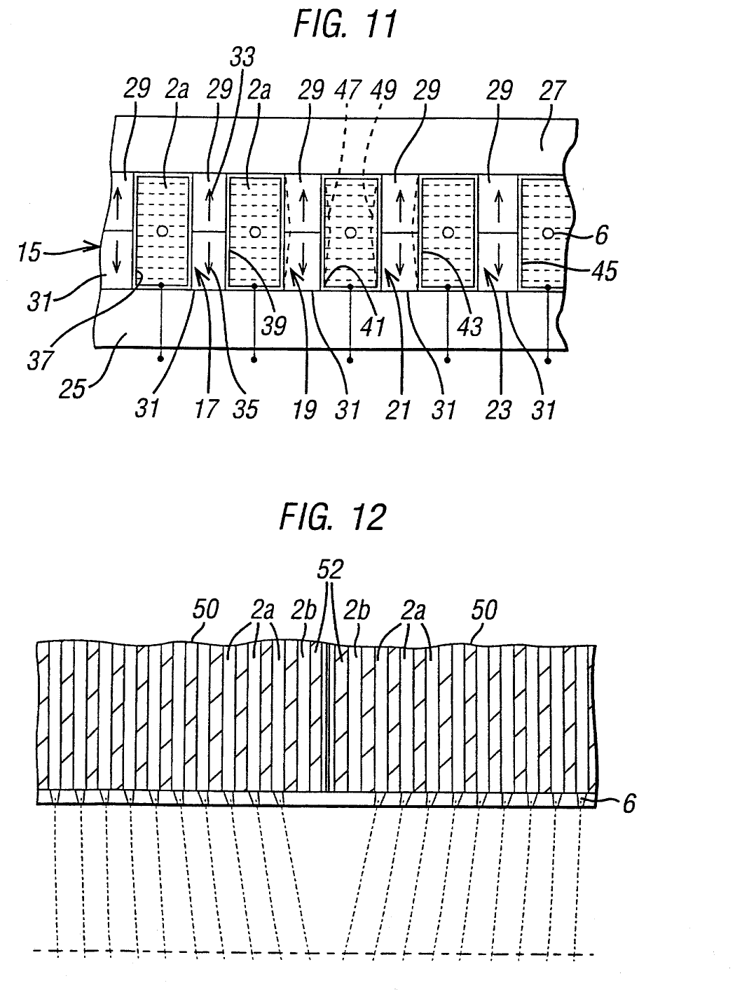

FIG. 11 is a section through the printhead of FIG. 10;

FIG. 12 is a diagrammatic plan view illustrating an example of the nozzle forming stage of the printhead;

FIG. 13 illustrates the arrangement of a bridge circuit used to provide a signal indicative of the temperature of fluid in the printhead; and

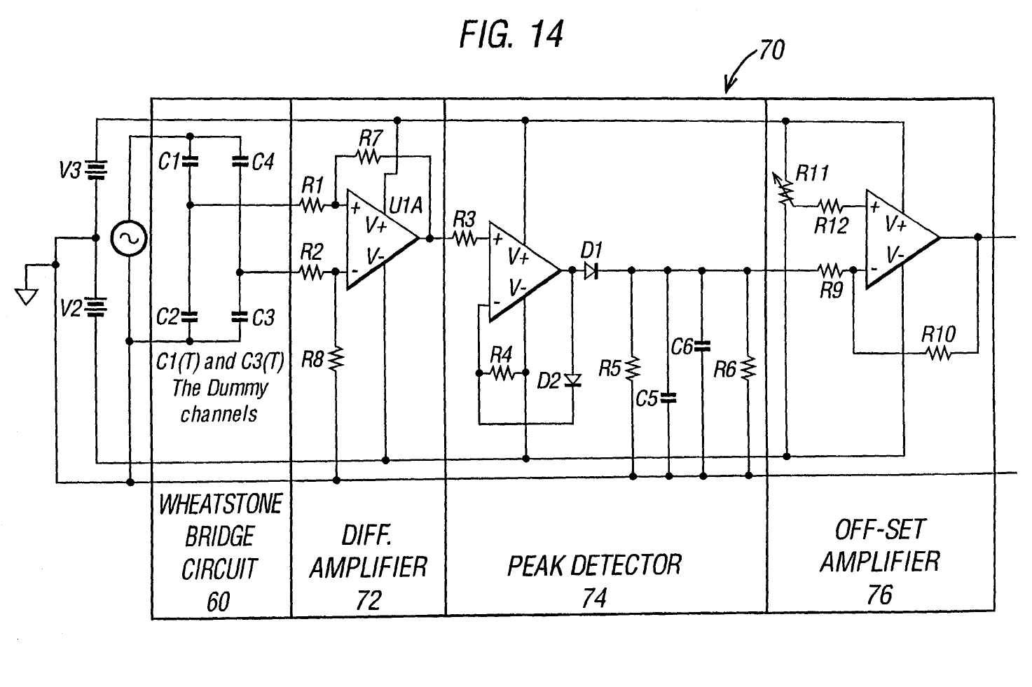

FIG. 14 illustrates a compensation circuit including the bridge circuit of FIG. 13.

FIG. 1 is an exploded partly diagrammatic perspective view of a part of an actuator 100. Ink is supplied from an ink reservoir (not shown) to an ink inlet 150 on the actuator assembly 100. The ink inlet 150 may include a filter 160. The actuator 100 comprises an actuator plate 200 and a cover plate 210. The actuator plate 200 is made from polarised piezoelectric material. The cover plate, which includes the ink inlet 150, may be made from piezoelectric material which is not polarised.

The actuator plate 200 includes grooves of a rectangular cross-section forming channels 220. The channels 220 are separated by side walls 230. The whole actuator plate is poled in a direction parallel to the Z-axis in FIG. 1. The direction of polarisation is also illustrated by arrows 240 in FIG. 1. As described in more detail below, the channels are divided into fluid ejection channels and “dummy” channels from which is not, or not intended to be, ejected during printing.

FIG. 2 is a sectional perspective view of a part of the actuator plate 200. A bond wire D1 connects to a thin metal layer 270 (illustrated by dashed lines) arranged on a surface of the actuator plate 200. The metal layer also covers a part of the surface of the wall 230 facing towards channel CH1 of the wall 230 as illustrated by the shaded area E1 in FIG. 2. Another bond wire D2 connects to metal layers E2 in channel CH2 in the same manner. The metal layers E2 form electrodes on the surfaces facing channel CH2 of the walls 230. The actuator has N channels, which during operation of the actuator are filled with ink. An embodiment of the actuator has 66 channels (N=66). The cover plate 210 is cemented onto the actuator plate 220 so as to define, together with the walls 230, channels 220 with nozzles F2, F3 . . . FN−1.

Each wall 230 is individually displaceable in dependence on the current between the electrodes on that wall. For example, the wall between channel CH2 and channel CH3 is displaceable in dependence on a current I₂₃ from electrode E2 to electrode E3.

FIG. 3 illustrates examples of electric pulses 11-14 delivered to the electrodes E1-E4 when a maximal number of ink droplets are to be ejected.

FIG. 4 illustrates an example of an electric signal wave form U₂₃ relating to the two opposing electrodes E2 and E3 on the wall between channel CH2 and channel CH3. This wave form is obtained in response to the currents 12 and 13 shown in FIG. 3.

FIG. 5 is a block diagram of an embodiment of the invention, comprising an actuator 100, an actuator control circuit 130, a power supply circuit 330, and a temperature sensor 500. The power supply circuit 330 is coupled to a DC power supply 340. The power supply 340 may for example provide a substantially constant voltage V_{DC} of 40 volts. The power supply circuit 330 comprises a drive voltage controller 350, having an input 360 for a control signal and a power supply output 370 for delivering a drive voltage with a controlled voltage V_{cc}. The controlled voltage V_{cc} may for example be controllable from 10% of V_{cc(100)} to 100% of V_{cc(100)}, where V_{cc(100)}=35volts.

With reference to FIG. 4 the peak voltage level of the electric drive signals delivered to the actuator walls 230 equals the controlled voltage V_{cc}. The invention is not limited to this, however, but the peak voltage level of the electric drive signals could also have a value which differs from the value of the controlled voltage V_{cc} but which is dependent thereon.

The actuator control unit 130 comprises a power supply input 380 which is coupled to the output 370 receiving the controlled drive voltage V_{cc}. The control unit 130 comprises a plurality, N, of controllable drive signal sources 320:1-320:N, each drive signal source having a drive voltage input 400 which is coupled to the power supply input 380. Each drive signal source has an earth connection 410 and an actuator drive signal output 420. Each actuator drive signal output is coupled to the electrodes E of a corresponding channel wall in the actuator 100.

Each drive signal source 320 also comprises an input 430 for a current control signal. The current control signal input is coupled to a data conversion unit 440. The data conversion unit comprises an input 450 for receiving print data indicative of the text or picture to be printed. The input 450 is adapted to be connected to a data interface 460 via a databus 464. A plurality of electrical conductors 466 are provided to connect the control unit 130 with the data interface 460 and the power supply circuit 330.

According to an embodiment of the invention, the actuator control circuit 130 and the actuator 100 are arranged on a movable shuttle in a printer, while the data interface 460 and the drive voltage controller 350 are stationary parts in the printer.

The data conversion unit 440 converts print data received on the input 450 into individual current control signals for each drive signal source 320. For this purpose the data conversion unit 440 comprises a control signal output 468 corresponding to each drive signal source 320, and hence a current control signal for each channel in the actuator.

The data conversion unit in co-operation with the controllable drive signal source 320 operates to generate drive currents on the outputs 420 such that the wave forms of the drive signals delivered to each actuator wall causes a controlled movement of each wall, thereby causing ejection of ink droplets.

During printing the actuator will generate Joule heat. The actuator control circuit 130, which may be embodied as an integrated circuit, will be warmed up to a certain extent. The heat may dissipate to the actuator and the ink in the channels 220 will be warmed up. Certain essential properties of the ink, such as viscosity, change in dependence on ink temperature. For some ink types an increase of the ink temperature leads to a decreased ink viscosity. This in turn leads to an increase in drop velocity. This leads to a problem for print quality, since the ink dot placement in the printing process depends on the drop velocity.

In order to compensate for such ink viscosity variations, the drive signals delivered to the actuator walls can be adjusted. The more accurate the measurement of the ink temperature the better the control of ink velocity and print quality.

In order to compensate for this temperature dependency, the temperature of the actuator assembly is measured by a temperature sensor 500 (FIG. 5) and the voltage levels in the pulse wave forms are decreased with rising ink temperature. According to an embodiment of the invention the voltage top value V_{cc(100)} is set to 35 volts when the actuator temperature is 20° C. The voltage top value is herein referred to as the 100% voltage level.

According to prior art, a discrete thermistor (i.e. a temperature dependent resistor) is provided on the outside of the actuator. The thermistor is coupled to an electrical circuit such that the actuator drive voltage amplitude is decreased in response to an increased thermistor temperature. Unfortunately the position of the discrete thermistor on the external surface of the actuator leads to a mismatch between the thermistor temperature and the actual temperature of the ink, due to thermal insulation provided by the actuator body and, sometimes by a glue layer used for attaching the thermistor. Particularly in the course of fast temperature changes in the actuator this problem can lead to measurement errors, resulting in inferior print quality.

In the embodiment shown in FIG. 5, there is provided a sensor 500 for measuring the ink temperature in the actuator. The sensor 500 includes a circuit for measuring the capacitance of a wall 230. The capacitance of a wall is measured between two electrodes, such as electrode E1 and E2 shown in FIG. 5. The inventors have verified by experimentation that the capacitance of a channel wall 230 in a piezo-electric actuator is substantially linear function of temperature. The sensor 500 delivers a signal indicative of the sensed ink temperature to the input 360 power supply circuit 330, which in turn adjusts the drive voltage V_{cc}, thereby compensating for any ink viscosity changes. Hence, the electric signals (FIG. 4) delivered to the walls in order to deform them to cause liquid in said channels to be ejected therefrom, are adjusted in accordance with the impedance of the piezo-electric material.

The sensor 500, shown in FIG. 5, includes a Wheatstone bridge having four impedances C1, C2, C3 and C4, one of which (C1) is constituted by a portion of piezo-electric material in the actuator 100. Hence, the sensor 500 is at least to a certain extent an integrated part of the actuator. The temperature dependent impedance C1(T) constitutes an active sensor element in the Wheatstone bridge 510. The Wheatstone bridge is provided with a drive voltage U_{w}. The Wheatstone bridge generates a differential voltage U_{d}, which is delivered to an amplifier 520. The input signal from the amplifier 520 is delivered to the control input 360 of power supply circuit 330.

FIG. 6 illustrates the correlation between the temperature of a portion of a piezo-electric actuator wall and the capacitance of that wall portion. The crosses in the figure illustrate measured values. It can be clearly seen that the values correlate well to a straight line, i.e. there is a linear relationship between temperature and capacitance in the piezo-electric material. A straight line has been adapted to the measured values for illustrating the linear correlation between temperature T and capacitance C. Since the channel walls are in direct contact with the ink in the actuator the temperature of the wall will be the same, or substantially the same as that of the ink. Hence, the capacitance of the channel wall capacitance provides an advantageously direct and fast indication of the temperature of the ink.

FIG. 7 illustrates another embodiment of a Wheatstone bridge having four capacitors C1, C2, C3 and C4. Two capacitors C1 and C3 form active sensor elements and are constituted by electrodes on opposing sides of channel walls 230, thereby providing a temperature dependent difference voltage U_{d}. According to one embodiment the walls of the first and the last channels CH1 and CHN are used for impedance measurement. In an actuator embodiment having 66 channels (N=66), the wall between channels CH1 and CH2 is used as C1(T) and the wall between channels CH65 and CH66 is used as C3(T). The capacitors C2 and C4 are discrete capacitors components, the capacitance of which is substantially independent of temperature. The capacitance of C4 is chosen to be substantially equal to the capacitance C1(T) and the capacitance of C2 is chosen to be substantially equal to the capacitance C3(T) at a selected temperature Tₛ, such that the Wheatstone bridge is matched at the selected temperature. In other words the difference voltage U_{d} equals zero volts at the selected temperature Tₛ. The selected temperature Tₛ could be e.g. 22 degrees Centigrade.

Since the values C1(T) and C3(T) increase with an increasing temperature, there will be a non-zero output voltage U_{d} at temperatures deviating from the selected temperature. Due to the proportionality of C1(T) and C3(T) to temperature, the output voltage U_{d} will also be proportional to temperature.

FIG. 8 illustrates an embodiment of a Wheatstone bridge 510 and an amplifier 520. The amplifier circuit 520 includes a differential amplifier 530, a peak detector 540 and an off-set amplifier 550. This circuity enables adjustment of the relation between the output U_{d} of the Wheatstone bridge and the signal level delivered to the control input 360.

According to another embodiment the amplification of the amplifier 520 can be non-linear, so that compensation with non-linear temperature characteristics can be achieved. This may be used for an ink type having a viscosity with a non-linear dependence on temperature.

FIG. 9 illustrates another embodiment of the invention, comprising a temperature sensor including a Wheatstone bridge with two active elements C1 and C3. The active element C3 is formed by the wall 230 between the N:th “dummy” channel and the adjacent fluid ejecting channel CHN−1. That same wall may be actuated to move in response to signals delivered by drive signal sources 320:N and 320:N−1, as indicated in FIG. 9.

Although in the above described embodiments the temperature dependent impedance is constituted by walls or wall segments defining channels in the actuator, the invention also embraces impedance measurements of other portions of the actuator having a temperature dependent impedance. The actuator plate 200 or the cover plate 210 may include a portion of piezoelectric material between electrodes so as to define a temperature dependent impedance (not shown). This temperature dependent impedance, or several such impedances, may be coupled in a voltage divider or in a Wheatstone bridge, as described above. Such a temperature dependent impedance is preferably positioned near the actuator channels, so as to adequately indicate the temperature of ink therein. Although the above embodiments discuss the measurements of capacitance, it is well known that capacitance is a part of an impedance. In other words, when the capacitance changes so does the impedance.

Referring now to FIG. 10, a planar array, drop-on demand ink jet printer according to another embodiment of the present invention comprises a printhead 10 formed with a multiplicity of parallel fluid chambers or channels 2a,2b, nine only of which are shown and the longitudinal axes of which are disposed in a plane. The channels 2a,2b are closed by a cover (not shown) which extends over the entire top surface of the printhead. As described in more detail below, the channels are divided into fluid ejection channels 2a and “dummy” channels 2b, from which fluid is not, or not intended to be, ejected during printing.

The channels are of end-shooter configuration, terminating at corresponding ends thereof in a nozzle plate 5 in which are formed nozzles 6, one for each fluid ejection channel 2a. Fluid, such as ink 4, is ejected on demand from the fluid ejection channels 2a in the form of droplets 7 and deposited on a print line 8 of a print surface 9 between which and the printhead 10 there is relative motion normal to the plane of the channel axes.

The printhead 10 has a planar base part 20 in which the channels 2a,2b are cut or otherwise formed of a PZT piezoelectric material so as to extend in parallel rearwardly from the nozzle plate 5. The channels 2a,2b are long and narrow with a rectangular cross-section and have opposite side walls 11 which extend the length of the channels. The side walls 11 of the fluid ejection channels 2a are provided with electrodes (not shown) extending along the length of the channels whereby the side walls are displaceable in shear mode transversely relatively to the channel axes along substantially the whole of the length thereof, to cause changes of pressure in the ink in the channels 2a to effect droplet ejection from the nozzle.

The channels 2a, 2b connect at their ends remote from the nozzles, with a transverse channel (not shown) which in turn connects with an ink reservoir (not shown) by way of pipe 14. Electrical connections (not shown) for activating the side walls 11 of the fluid ejection channels are made to an LSI chip 16 on the base part 20.

As shown in FIG. 11, the channel side walls 11 have oppositely-poled regions so that application of an electric field deflects them into a chevron shape. The array incorporates displaceable side walls 11 in the form of shear mode actuators 15, 17, 19, 21 and 23 sandwiched between base and top walls 25 and 27 and each formed of upper and lower wall parts 29 and 31 which, as indicated by arrows 33 and 35, are poled in opposite senses normal to the plane containing the channel axes.

The inner walls of the fluid ejection channels 2a are covered by respective electrodes 37, 39, 41, 43 and 45. Thus, when a voltage is applied to the electrode of a particular channel, say electrode 41 of the channel 2a between shear mode actuator 19 and 21, whilst the electrodes 39 and 43 of the channels 2a on either side of that of electrode 41 are held to ground, an electric field is applied in opposite senses to the actuators 19 and 21. By virtue of the opposite poling of the upper and lower wall parts 29 and 31 of each actuator, these are deflected in shear mode into the channel 2a therebetween in chevron form as indicated by broken lines 47 and 49. An impulse is thus applied to the ink 4 in the channel 2a between the actuators 19 and 21 which causes an acoustic pressure wave to travel along the length of the channel and eject an ink droplet 7 therefrom.

As mentioned above, the printhead includes dummy channels 2b from which ink is not ejected during printing. A dummy channel 2b may be located adjacent each fluid ejection channel 2a. Alternatively, or additionally, a plurality of fluid ejection channels 2a may be located between a pair of dummy channels. As shown in FIG. 12, in a preferred arrangement described in our printed specification WO91/17051, a dummy channel 2b is located at each end of a printhead module 50 (one end only of each module 50 is shown in FIG. 12), the printhead 10 comprising a plurality of modules 50. In this arrangement, the nozzles 6 of the fluid ejection channels 2a are ablated with their axes slightly fanned so that droplets ejected from the channels 2a are substantially equally spaced along the print line 8 on the print surface 9. As there is no ink ejection from the dummy channels 2b, the walls 52 of the dummy channels are not connected to the chip 16, and thus are non-actuable.

During printing, heat is generated by, for example, the chip 16. This heat dissipates into the fluid chambers 2a,2b and increases the temperature of the ink 4, which gives rise to a decrease in the viscosity of the ink 4. Such variations in the viscosity of the ink can result in variations in droplet ejection velocity and consequent dot placement errors in the printed image. To seek to avoid such errors, the temperature of the ink is monitored during printing. This enables the magnitude of the actuating signals applied to the walls 11 of the fluid ejection chambers 2a to be adjusted in response to the monitored temperature so as to compensate for the decrease in the viscosity of the ink.

In the present embodiment a temperature dependent electrical property of a non-actuable wall 52 of a dummy chamber 2b is used to monitor the temperature of ink 4 during printing. As the walls 52 are in direct contact with the ink 4, any rapid changes in the temperature of the ink 4 can be detected and acted upon quickly. Furthermore, as the wall 52 is non-actuable any necessary application of electrical signals to the wall 52 for measurement of the chosen electrical property of the wall has no influence on the standard printing operation of the printhead.

FIGS. 13 and 14 illustrate an embodiment of an arrangement for utilising the capacitance of the non-actuable walls 52 of a pair of dummy channels 2b to provide an indication of the temperature of the ink 4 in the fluid ejection channels located between the dummy channels. With reference to FIG. 6, the inventors of the present application have found, and verified experimentally, that the capacitance of the walls 11,52 of a channel 2a,2b is a substantially linear function of temperature. As a consequence, the magnitude of the temperature dependent signal can be directly proportional to the temperature of the ink.

With reference to FIG. 13, a bridge circuit 60 is used to provide a signal having a magnitude dependant on the temperature of ink in the channels 2a, 2b. Each arm of the bridge circuit 60 includes a capacitor. Each of the capacitors C1 and C3 is provided by a respective non-actuable wall 52 of a dummy channel 2b. Each of the capacitors C2 and C4 is provided by a capacitor having a capacitance which is not variable with temperature and which is substantially equal to the capacitance of a dummy channels 2b at room temperature.

An alternating voltage V1 is input to the bridge circuit. Any variation of the capacitance of the capacitors C1 and C3, due to deviation of the temperature of the ink 4 from room temperature, results in a signal being output from the bridge circuit, the magnitude of the signal indicating the temperature of the ink in the channels 2a,2b. To enable the signal output from the bridge circuit to be used to adjust the magnitude of the actuating electrical signals, the signal is shaped using a shaping circuit, an example of which is shown in FIG. 14. The shaping circuit 70 of FIG. 14 includes a differential amplifier 72, peak detector 74 and offset amplifier 76, from which is output a temperature dependent voltage signal which is superimposed on the actuating electrical signals supplied to the walls 11 from the chip 16. This in turn modifies the velocity of the droplets ejected from the ejection channels 2a so as to avoid drop placement errors.

It will be understood that the present invention has been described above purely by way of example, and modifications of detail can be made within the scope of the invention.

For example, although the present invention as been described with reference to an “end-shooter” printhead, it is equally applicable to a “side shooter” or any other form of printhead.

Furthermore, any suitable means may be employed for detecting the capacitance, or other suitable electrical property, of the walls of the dummy channels. For example, a digital detection circuit may be employed in order to avoid problems associated with the generation of noise during detection of the chosen electrical property. In addition, the arrangement of the shaping circuit is not limited to that shown in FIG. 14. For example, a different amplification arrangement may be used so that temperature dependent voltage signals having various linear or non-linear variations with temperature can be output to adjust the actuating electrical signals for different types of inks.

Each feature disclosed in this specification (which term includes the claims) and/or shown in the drawings may be incorporated in the invention independently of other disclosed and/or illustrated features.

1. Droplet deposition apparatus including an array of fluid-receiving chambers comprising a plurality of fluid ejection chambers and at least one dummy chamber, each fluid ejection chamber comprising means for ejecting a droplet therefrom in response to an electrical actuating signal, characterised by:
means exposed to fluid in the dummy chamber to provide a signal dependent on the temperature of that fluid; and
means responsive to the temperature dependent signal for adjusting the actuating electrical signals.

2. Apparatus according to claim 1, wherein each fluid ejection chamber is defined in part by at least one wall actuable by an electrical signal to effect droplet ejection from that chamber, a corresponding wall of each dummy chamber being non-actuable, the apparatus comprising means for utilising a temperature dependent electrical property of at least a portion of a wall of a dummy chamber to provide said signal.

3. Droplet deposition apparatus comprising:
a plurality of fluid chambers comprising at least one fluid ejection chamber and at least one dummy chamber, each fluid ejection chamber being defined in part by at least one wall actuable by an electrical signal to effect droplet ejection from that chamber, a corresponding wall of each dummy chamber being non-actuable;
characterised by further comprising:
means for utilising a temperature dependent electrical property of at least a portion of a wall of a dummy chamber to provide a signal having a magnitude dependant on the temperature of fluid in the fluid chambers; and
means for adjusting the magnitude of the actuating electrical signals depending on the magnitude of the temperature dependant signal.

4. Apparatus according to claim 2 or claim 3, wherein said temperature dependent electrical property is electrical capacitance.

5. Apparatus according to any of claims 2 to 4, wherein said utilising means comprises a bridge circuit having four arms, each of two arms of the bridge circuit comprising said at least a portion of said wall of a respective dummy chamber.

6. Apparatus according to claim 5, wherein each of the other two arms of the bridge circuit comprises a temperature independent capacitor, the capacitance of each capacitor being substantially equal to the capacitance of each portion of said wall at room temperature.

7. Apparatus according to any of claims 2 to 6, wherein said utilising means utilizes a temperature dependent electrical property of at least a portion of said corresponding wall of a dummy chamber to provide said signal.

8. Apparatus according to any of claims 2 to 6, wherein said walls are formed from piezoelectric material, each actuable channel wall being deformable upon the application of an actuating electrical signal to eject fluid from a fluid ejection chamber.

9. Apparatus according to claim 8, wherein said piezoelectric material is such that application of the actuating electrical signal deforms it in shear mode to generate an acoustic pressure wave in the fluid ejection chamber and thereby eject said fluid.

10. Apparatus according to claim 8 or 9, wherein the piezoelectric material is disposed along the sides of each fluid chamber.

11. Apparatus according to any preceding claim, comprising means for shaping said temperature dependent signal to provide a temperature dependent voltage signal for superimposition by said adjusting means on said actuating electrical signals.

12. A method of temperature compensation in droplet deposition apparatus having an array of liquid-containing channels, at least one of which is a dummy channel, the others being droplet-ejection channels, characterised by controlling a droplet-ejection signal to a droplet-ejection channel in response to a signal which is dependent upon the temperature of liquid in a dummy channel.

13. A method of operating droplet deposition apparatus comprising a plurality of fluid chambers comprising at least one fluid ejection chamber and at least one dummy chamber, each fluid ejection chamber being defined in part by at least one wall actuable by an electrical signal to effect droplet ejection from that chamber, a corresponding wall of each dummy chamber being non-actuable, said method being characterised by comprising the steps of;
utilising a temperature dependent electrical property of at least a portion of a wall of a dummy chamber to provide a signal having a magnitude dependent on the temperature of fluid in the fluid chambers; and
adjusting the magnitude of the actuating electrical signals depending on the magnitude of the temperature dependant signal.

14. Droplet deposition apparatus comprising:
an actuator having a plurality of spaced piezoelectric walls defining liquid-containing channels, said walls having opposed sides; said opposed sides being provided with electrodes adapted to receive electric signals to deform said walls to cause liquid in said channels to be ejected therefrom; and
a control unit for defining wave forms of said electric signals and comprising means for measuring an impedance of one of said piezoelectric walls to provide a signal having a magnitude dependent on the temperature of liquid directly contacting that wall in an adjacent liquid-containing channel, and means for adjusting the wave forms of said electric signals in response to the measured impedance.

15. Apparatus according to claim 14, further comprising:
a reference impedance, the impedance value of which is substantially unaffected by the temperature of the actuator, the reference impedance in combination with the impedance of said piezoelectric portion being coupled as a voltage divider such that a sensor output voltage is generated, said adjustment means being coupled so as to receive the sensor output voltage.

16. Apparatus according to any of claims 14 to 15, wherein the adjustment means includes means for adjusting the peak voltage level of the electric signals.

17. Apparatus according to any of claims 14 to 16, wherein the impedance measurement means includes a Wheatstone bridge.

18. Apparatus according to any of claims 14 to 17, wherein the impedance measurement means at least to a certain extent is an integrated part of the actuator.

19. A control unit for a piezoelectric actuator having a plurality of spaced piezoelectric walls defining liquid-containing channels, said walls having opposed sides provided with electrodes adapted to receive electric signals to deform said walls to cause liquid in said channels to be elected therefrom; the control unit comprising:
a plurality of controllable drive signal sources for generating electric signals to deform said walls;
means for measuring an impedance, preferably capacitance, of one of said piezoelectric walls to provide a signal having a magnitude dependent on the temperature of liquid directly contacting that wall in an adjacent liquid-containing channel, and means for adjusting the wave forms of said electric signals in response to the measured impedance.

20. A control unit according to claim 19, further comprising:
a reference impedance, the impedance value of which is substantially unaffected by the temperature fo the actuator, the reference impedance in combination with the measured impedance being coupled as a voltage divider such that a sensor output voltage is generated, said adjustment means being coupled so as to receive the sensor output voltage.

21. An ink jet printer comprising a control unit according to claim 19 or claim 20.

22. Droplet deposition apparatus or a method of operating droplet deposition apparatus substantially as herein described with reference to the accompanying drawings.
